(19) United States
(12) Patent Application Publication
(10) Pub. No.: US 2026/0071808 A1
(43) Pub. Date: Mar. 12, 2026

(54) REFRIGERATOR

(71) Applicant: LG Electronics Inc., Seoul (KR)

(72) Inventors: Yonghyun CHO, Seoul (KR); Jaehun PARK, Seoul (KR); Seonyong JANG, Seoul (KR)

(21) Appl. No.: 19/323,075

(22) Filed: Sep. 9, 2025

(30) Foreign Application Priority Data
Sep. 9, 2024 (KR) 10-2024-0122480

(51) Int. Cl. F25D 23/02; F21V 33/00; F21W 131/305

(52) U.S. Cl. CPC F25D 23/028; F21V 33/0044; F21W 2131/305; F25D 2323/024

(57) ABSTRACT

A refrigerator includes: a cabinet having a storage space with an open front; a door configured to open and close the storage space; a hinge including a hinge plate mounted on the cabinet and a pair of hinge pins protruding from the hinge plate; and a guide member provided on the door to allow the pair of hinge pins to be inserted and forming a path along which the hinge pins move when the door is opened and closed. A plate opening is formed in the hinge plate through which a wire extending from the interior of the door passes and is guided toward the cabinet.

### CROSS-REFERENCE TO RELATED APPLICATIONS

The present application claims the benefits of priority to Korean Patent Application No. 10-2024-0122480, filed on Sep. 9, 2024, of which its incorporated herein by reference in its entirety.

### BACKGROUND

### 1. The Field

The present invention is related to a refrigerator.

### 2. Description of the Related Art

Generally, a refrigerator is a home appliance that stores food at low temperatures within an internal storage space enclosed by a door. To achieve this, refrigerators utilize the cold air generated by heat exchange with the refrigerant circulating in the refrigeration cycle to cool the interior of the storage space, thereby maintaining optimal storage conditions for stored food.

Recently, refrigerators have become increasingly larger and more multifunctional, reflecting changing dietary habits and the trend toward higher-end products. A variety of refrigerator designs are being released, tailored to user convenience.

Recently, refrigerators have been designed to be embedded in walls or integrated with other furniture or appliances. In these cases, a certain amount of clearance is required to prevent the corners of the door from interfering with neighboring walls, furniture, or appliances.

To achieve this, refrigerators are being developed in which the top and bottom of the door are supported by multiple hinge pins, allowing the door to open and close by varying its center of rotation.

However, in the case of refrigerators like this, there is a problem that the center of rotation of the door is not fixed, making it difficult to arrange the wires extending from the door to the main body.

### SUMMARY

The present invention is directed to providing a refrigerator that facilitates the arrangement of a wire extending into the cabinet from a refrigerator door whose rotational center changes during opening and closing.

The present invention is further directed to providing a refrigerator capable of preventing damage to a wire extending toward the cabinet from a refrigerator door in which a plurality of hinge pins are connected to one side of the door.

The present invention is also directed to providing a refrigerator capable of preventing external exposure of a wire extending toward the cabinet from a refrigerator door in which a plurality of hinge pins are connected to one side of the door.

A refrigerator according to an embodiment of the present invention may comprise: a cabinet having a storage space with an open front; a door configured to open and close the storage space; a hinge including a hinge plate mounted on the cabinet and a pair of hinge pins protruding from the hinge plate; and a guide member provided on the door to allow the pair of hinge pins to be inserted and forming a path along which the hinge pins move when the door is opened and closed; and wherein a plate opening may be formed in the hinge plate through which a wire extending from the interior of the door passes and is guided toward the cabinet.

A wire hole formed independently of the guide member may be formed on one surface of the door provided with the guide member, and the wire may pass through the wire hole and may be guided to the outside of the door.

The wire hole may be formed at a position facing the plate opening.

The wire hole may overlap at least a portion of the plate opening in a vertical direction. The plate opening may be formed along a moving trajectory of the wire hole when the door is opened or closed.

The plate opening may extend longer than the wire hole, and the plate opening may maintain a vertical overlap with a portion of the wire hole even during the opening or closing of the door.

The wire hole may be located in a region between both ends of the guide member and may be disposed further rearward than the guide member.

The hinge plate may include: a fixing portion fixed to the lower surface of the cabinet; and a support portion extending from the fixing portion and protruding further forward than the cabinet, and to which the pair of hinge pins are mounted, and wherein the plate opening may be formed at the support portion.

The plate opening may be formed in the support portion and extends from the rear of the pair of hinge pins to pass through both of the pair of hinge pins.

The plate opening may comprise: a first part extending from an end of the support portion to pass the pair of hinge pins; and a second part extending forward in a rounded manner from an end of the first part, and wherein the second part may have a greater curvature than the first part.

The first part may be formed in a linear shape.

The hinge plate may further include a bending portion formed by bending along the side edges of the support portion and the fixing portion, and wherein the bending portion may be adjacent to an end of both ends of the plate opening.

The hinge plate further may include a reinforcing portion protruding along a portion of the periphery of the support portion, and wherein the reinforcing portion may be adjacent to another end of both ends of the plate opening.

A fixing portion opening may be formed in the fixing portion, and the fixing portion opening being configured to guide the wire, which has passed through the plate opening, toward the cabinet.

A hinge cover that shields the hinge may be coupled to the hinge plate, and the hinge cover may cover both the plate opening and the fixing portion opening.

The hinge may connect a lower surface of the cabinet and a lower surface of the door. The pair of hinge pins may extend in parallel at spaced-apart positions so as to contact an inner surface of the guide member, and a point of contact between the hinge pins and the inner surface of the guide member may be continuously changed during opening and closing of the door.

The door may comprise: a front panel defining a front surface of the door and being light-transmissive; a lighting device provided in the door, the lighting device being configured to irradiate light toward the front panel to adjust a color of the front surface of the door; and a cap deco defining an upper surface or a lower surface of the door, wherein the wire may extend from the lighting device and is guided into the cabinet through a wire hole formed in the cap deco and the plate opening.

The guide member may comprise a pair of guide grooves formed independently of each other, and the pair of hinge pins are respectively inserted into the pair of guide grooves. In another aspect, the refrigerator according to an embodiment of the present invention may comprise: a cabinet having a storage space; a door configured to open and close the storage space; a hinge including a hinge plate mounted to the cabinet and a hinge portion protruding from the hinge plate toward the door; a guide member provided in the door such that the hinge portion is inserted therein, the guide member forming a path along which the hinge portion moves during opening and closing of the door; and a wire disposed inside the door and extending through the hinge to be guided into the cabinet, wherein the hinge portion may be formed with a through-hole penetrating the hinge portion, and wherein the guide member is formed with a guide hole opened at a position facing the through-hole and opened along the path, and wherein the wire passes through the guide hole and the through-hole to be guided from inside the door to the cabinet.

The refrigerator according to an embodiment of the present invention provides the following effects.

According to this embodiment, a plate opening is formed in the hinge plate at the lower surface of the door, and a wire hole is formed at the lower surface of the door, so that a wire inside the door can be easily guided toward the cabinet through the plate opening.

In particular, the door has a structure in which a rotational center changes during opening and closing, and even while the door is being opened and closed with a changing rotational center, the wire can be safely guided toward the cabinet through the wire hole and the plate opening.

Further, the wire of the door is guided into the cabinet while sequentially passing through the wire hole and the plate opening that are vertically overlapped with each other.

Accordingly, the wiring path can be minimized, thereby facilitating wiring operations.

In addition, during opening and closing of the door, the wire hole remains overlapped with the plate opening, so that the wire can be effectively guided without damage.

Since the wire passes through the hinge plate and the wiring path can be shielded by a hinge cover and a hinge cap, damage to the wire can be prevented. Moreover, as the wire is shielded by the hinge cover and the hinge cap, external exposure of the wire can also be prevented.

### BRIEF DESCRIPTION OF THE DRAWINGS

FIG. 1 is a perspective view of a refrigerator according to a first embodiment of the present invention.

FIG. 2 is a front view showing the door of the refrigerator in an open state.

FIG. 3 is a partial perspective view from below of the refrigerator with the hinge mounted.

FIG. 4 is a partial perspective view showing a coupling structure of the door and the guide member.

FIG. 5 is a partial bottom view of the door.

FIG. 6 is a plan view illustrating an arrangement of paths forming guide grooves of the guide member.

FIG. 7 is an exploded perspective view showing the hinge separated from the main body and the door.

FIG. 8 is a perspective view of the hinge.

FIG. 9 is an exploded perspective view showing a hinge cover and a hinge cap separated from the hinge.

FIG. 10 is a sectional perspective view taken along line 10-10 of FIG. 3.

FIG. 11 is a view showing an arrangement state of a wire and hinge pins when the door is in a closed state.

FIG. 12 is an enlarged view of part A of FIG. 11.

FIG. 13 is a view showing an arrangement state of a wire and hinge pins when the door is opened at a predetermined angle.

FIG. 14 is an enlarged view of part B of FIG. 13.

FIG. 15 is a view showing an arrangement state of a wire and hinge pins when the door is in a fully open state.

FIG. 16 is an enlarged view of part C of FIG. 15.

FIG. 17 is an exploded perspective view of a door according to a second embodiment of the present invention.

FIG. 18 is an exploded perspective view of a door according to a third embodiment of the present invention.

### DETAILED DESCRIPTION

Hereinafter, specific embodiments of the present disclosure will be described in detail with reference to the drawings. However, the present disclosure is not limited to the embodiments in which the idea of the present disclosure is presented, and other regressive disclosures or other embodiments included within the scope of the idea of the present disclosure can be easily proposed by adding, changing, deleting, or the like other components.

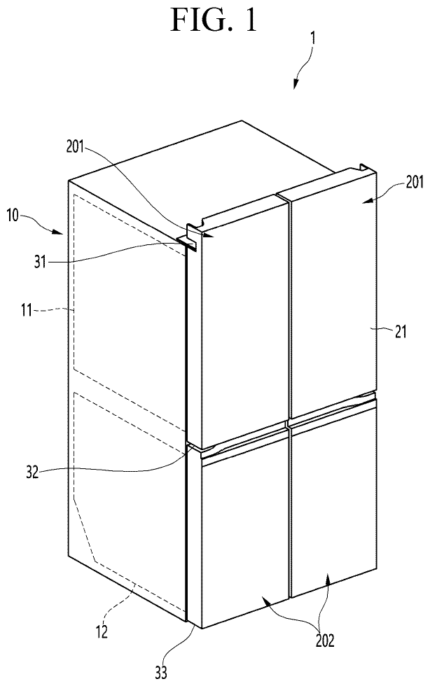

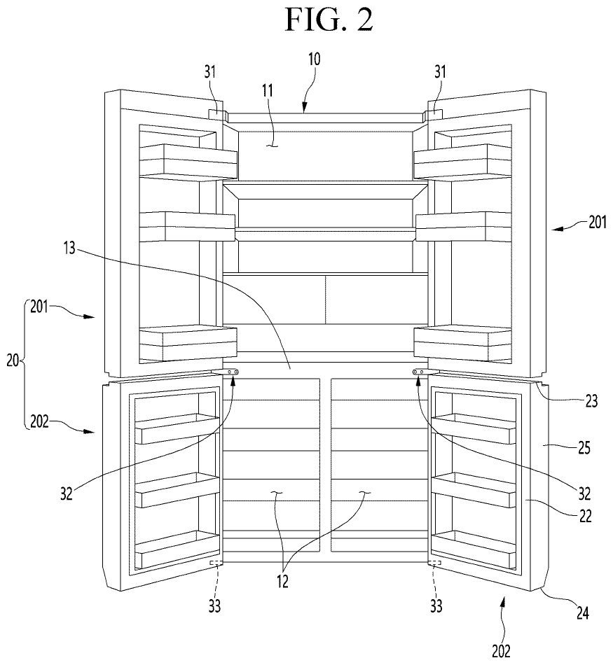

Before proceeding with the description, the directions are defined. In the embodiment of the present invention, the direction in which the front of the door as shown in FIGS. 1 and 2 faces is defined as forward, the direction toward the cabinet based on the front of the door is defined as rear, the direction toward the floor surface on which the refrigerator is installed is defined as downward, and the direction away from the floor surface is defined as upward. In addition, when discussing directions that are not defined, the direction can be defined and explained based on each drawing.

In addition, although the embodiment of the present invention describes a refrigerator in which a refrigerating compartment and a freezing compartment are arranged vertically and each has a door, it is to be noted in advance that the present invention is not limited to the structure and shape of the refrigerator and is applicable to all types of refrigerators having a rotating door.

FIG. 1 is a perspective view of a refrigerator according to a first embodiment of the present invention, and FIG. 2 is a front view showing the door of the refrigerator in an open state.

As illustrated, a refrigerator 1 according to an embodiment of the present invention may have an overall exterior formed by a cabinet 10, which defines a storage space with an open front, and a door 20 that opens and closes the storage space.

Furthermore, the refrigerator 1 may be installed so as to harmonize with furniture or walls in an indoor space. For example, a space corresponding to the size of the refrigerator 1 may be provided within furniture or a wall, in which the refrigerator 1 is accommodated, or it may be arranged in a built-in type configuration. In addition, the refrigerator 1 may also be installed such that multiple refrigerators are continuously arranged in parallel.

In such an arrangement of the refrigerator 1, the front of the refrigerator 1, that is, the front surface of the door 20, may be positioned very close to the furniture or wall, and may be located on the same or a closely adjacent plane so as to provide a sense of unity.

Looking in more detail at the structure of the refrigerator 1, the cabinet 10 may form an upper storage space 11 and a lower storage space 12 by partitioning the storage space in the vertical direction with a barrier 13. For example, the upper storage space 11 may serve as a refrigerating compartment, while the lower storage space 12 may serve as a freezing compartment.

The door 20 may be configured to open and close the storage space, and may include an upper door 201 for opening and closing the upper storage space 11 and a lower door 202 for opening and closing the lower storage space 12.

The door 20 may include a front panel 21 forming the front surface, a door liner 22 forming the rear surface, an upper cap 23 forming the upper surface, and a cap deco 24 forming the lower surface. In a state where the front panel 21, the door liner 22, the upper cap 23, and the cap deco 24 are coupled together, an insulating material may be filled inside the door 20. the door 20 may further include side frames 25 that form the left and right side surfaces.

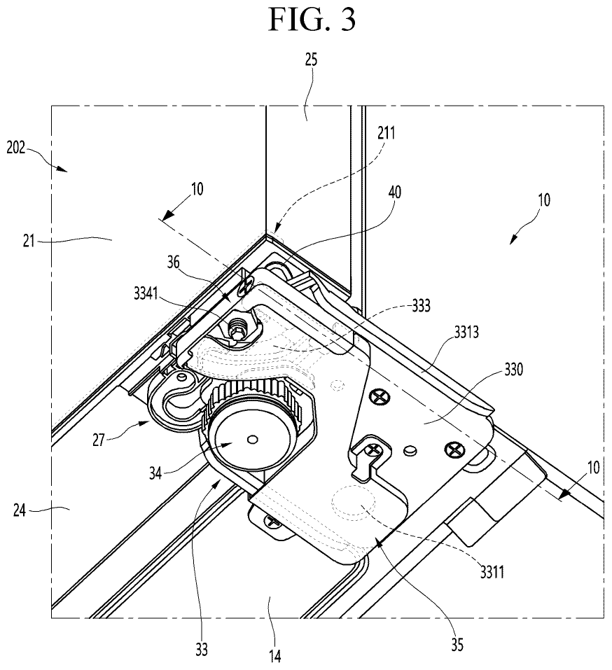

Meanwhile, the front panel 21 may be made of a material capable of transmitting light, and the color of the front panel 21 may be changed to a user-set color by the operation of a door light 211 provided inside the door 20 (as shown in FIG. 3). That is, the front appearance color of the door 20 and the refrigerator 1 may be adjusted according to the user's selection or operation. For this purpose, the door light 211 may include an RGB LED.

Meanwhile, the front panel 21 and the door light 211 may be configured as a panel assembly that is detachable from the door 20. The panel assembly, assembled separately from the door 20, may be mounted onto the door 20.

Both the upper doors 201 and the lower doors 202 may be arranged in pairs on the left and right sides, and may be configured to open and close by rotation. That is, the upper storage space 11 may be opened and closed by the pair of upper doors 201, and the lower storage space 12 may be opened and closed by the pair of lower doors 202.

The door 20 may be connected to the cabinet 10 by hinge devices 31, 32, and 33 so as to be rotatable. For example, a pair of upper doors 201 arranged on the left and right sides may be provided with a first hinge 31 and a second hinge 32 at their upper and lower ends. The upper doors 201 may be rotatably mounted to the cabinet 10 by means of the first hinge 31 and the second hinge 32.

The upper and lower ends of the lower door 202 may be provided with the second hinge 32 and the third hinge 33. The lower door 202 may be rotatably mounted to the cabinet 10 by means of the second hinge 32 and the third hinge 33.

The first hinge 31 may be referred to as an upper hinge, the second hinge 32 as a center hinge, and the third hinge 33 as a lower hinge.

The present invention is applicable to all types of refrigerators equipped with hinges, regardless of the form or arrangement of the doors, and may be applied to a refrigerator provided with a hinge that supports the door from below. However, for convenience of description and understanding, the following will describe, by way of example with reference to the drawings, the structure of the third hinge 33 that supports the lower door 202 from below. In this description, the lower door 202 may be referred to simply as the door 20, and the third hinge 33 may be referred to as the hinge 33.

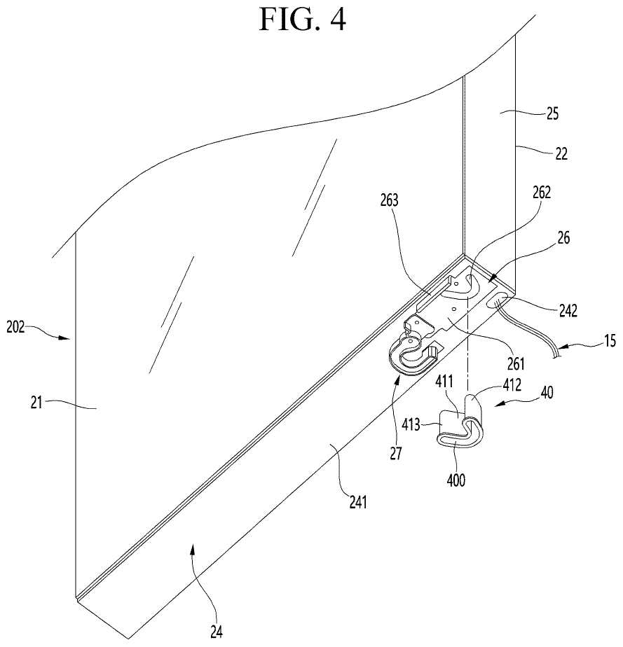

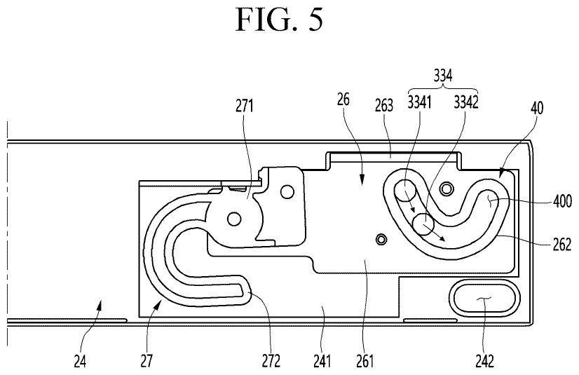

FIG. 3 is a partial perspective view from below of the refrigerator with the hinge mounted, FIG. 4 is a partial perspective view showing a coupling structure of the door and the guide member, and FIG. 5 is a partial bottom view of the door.

As illustrated, the hinge 33 may connect the cabinet 10 and the door 20. For example, the hinge 33 may be connected to the lower end of the door 20 and may rotatably support the door 20 from below.

The hinge 33 may be fixedly mounted at one side to the cabinet 10, and at the other side may be movably mounted along a guide groove 400 of a guide member 40 provided on the door 20. The hinge 33 may include a hinge plate 330 and a hinge pin 334.

The hinge plate 330 may be formed of a metal material and may be disposed below the cabinet 10 and the door 20. The hinge plate 330 may be fixedly mounted to the bottom surface of the cabinet 10, may further protrude forward beyond the front end of the cabinet 10, and may extend to below the door 20. The front end of the hinge plate 330 may extend to the guide member 40.

The hinge plate 330 may be provided with a pair of hinge pins 334. The hinge pins 334 may include a first hinge pin 3341 and a second hinge pin 3342 spaced apart from each other. The pair of hinge pins 334 may be positioned on the same vertical line as the hinge pins of the first hinge 31 and the second hinge 32. Accordingly, during the opening and closing process, the door 20 may move stably without eccentricity or shaking.

The hinge plate 330 may be provided with a leg 34. The leg 34 may contact the floor so that the refrigerator 1 is installed on the floor. The leg 34 may be configured to be height-adjustable by rotation, thereby allowing adjustment of the inclination of the cabinet 10.

Meanwhile, the hinge plate 330 may be provided with a hinge cover 35. The hinge cover 35 may be disposed below the hinge plate 330 to shield at least a portion of the hinge plate 330. The hinge cover 35 may be coupled to the hinge plate 330. The hinge cover 35 may shield a wire 15 that extends from the inside of the door 20, passes through the hinge 33, and then leads into the inside of the cabinet 10. In particular, the hinge cover 35 may be formed to shield both a plate opening 333 and a fixing portion opening 3311, which will be described below. The hinge cover 35 may also be provided with a cover cap 36. The cover cap 36 may shield a space between the hinge cover 35 and the hinge plate 330. Specifically, the cover cap 36 may shield the front and side portions between the hinge cover 35 and the hinge plate 330, thereby preventing the wire 15 and other components of the hinge 33 from being exposed to the outside.

Meanwhile, the lower surface of the door 20 may be formed by the cap deco 24. A stopper 27 may be mounted on the lower surface 241 of the cap deco 24. The stopper 27 may be engaged and restrained on one side of the hinge 33 when the door 20 is closed, thereby preventing the door 20 from being opened by reaction force. In other words, the engagement and restraint between the stopper 27 and the hinge 33 may allow the door 20 to remain closed without being unintentionally opened or moved.

The stopper 27 may be formed of a plastic material having elasticity. The stopper 27 may include a stopper mounting portion 271 that is fixedly mounted to the cap deco 24 by screws, and an elastic portion 272 that extends from the stopper mounting portion 271 and is selectively engaged and restrained by the hinge 33. The elastic portion 272 may be formed in a hook shape and may undergo elastic deformation when in contact with the hinge 33, thereby becoming engaged and restrained. Accordingly, when the door 20 is opened, the elastic portion 272 may deform and release its engagement with the hinge 33.

Meanwhile, the guide member 40 may be mounted on the lower surface 241 of the cap deco 24. The guide member 40 may be provided at the side of the stopper 27. The guide member 40 may be positioned at one end of the lower surface 241 of the cap deco 24. In addition, a reinforcing plate 26 may be disposed in the cap deco 24, and the guide member 40 may be mounted so as to penetrate through the reinforcing plate 26.

The reinforcing plate 26 may be formed of a plate-shaped metal material and may include a plate portion 261 fixedly mounted to the lower surface of the door 20. The reinforcing plate 26 may further include a plate hole 262 into which the guide member 40 is inserted. In addition, screws may be fastened to the plate portion 261 to fix the reinforcing plate 26 to the cap deco 24.

A restriction protrusion 263 bent downward may be formed at the front end of the plate portion 261. The restriction protrusion 263 may extend downward so as to contact one side of the hinge plate 330 when the door 20 is opened to its maximum extent.

The guide member 40 may be provided above in correspondence with the hinge pin 334. The guide member 40 may include a guide groove 400 into which the hinge pin 334 is inserted. The guide member 40 may also be arranged on the upper surface of the door 20 with the same structure, differing only in the mounting direction.

In a state where the guide member 40 is mounted on the lower surface of the door 20, the guide groove 400 may be exposed downward. The first hinge pin 3341 and the second hinge pin 3342 may be inserted into the inside of the guide groove 400. During the opening and closing operation of the door 20, the first hinge pin 3341 and the second hinge pin 3342 may move along the guide groove 400. The guide member 40 may include a pair of side portions 411, a first connecting portion 412, and a second connecting portion 413.

Meanwhile, the guide member 40 may be inserted and mounted on the lower surface 241 of the cap deco 24. Of course, the guide member 40 may also be integrally formed with the cap deco 24, or the guide groove 400 may be formed as a recess in the lower surface of the cap deco 24.

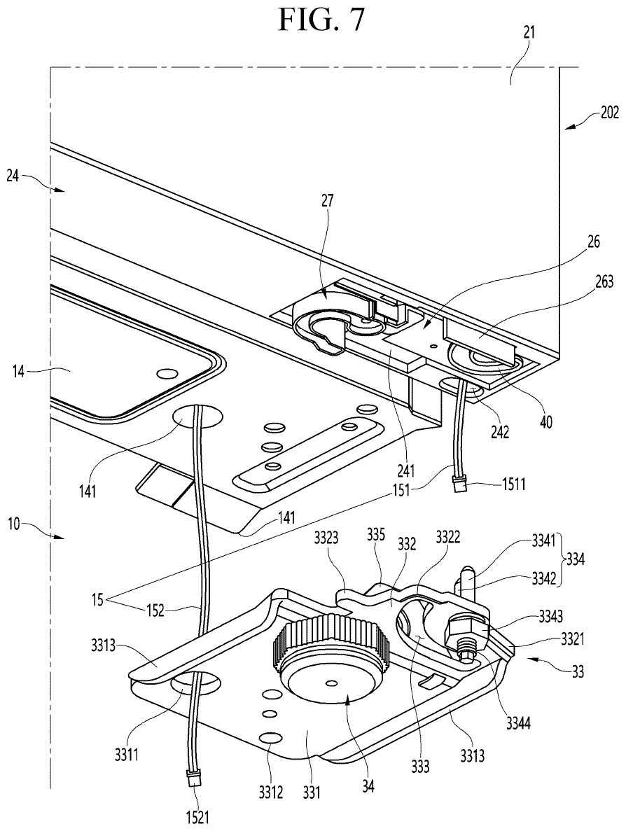

The door 20 may be provided with a wire hole 242 through which a wire 15 connected to electrical components provided in the door 20 passes. For example, the electrical component may be the door light 211, and the wire 15 connected to the door light 211 may be guided outside the door 20 through the wire hole 242 and extended into the cabinet 10. In one embodiment, the electrical component may be various electrical devices provided in the door, such as a heater, sensor, or display. For instance, the wire 15 may include a door-side wire 151 extending from the door 20 through the wire hole 242, and a cabinet-side wire 152 extending from the cabinet 10 through a cabinet opening 141 (shown in FIG. 7). The connector 1511 provided at the end of the door-side wire 151 and the connector 1521 provided at the end of the cabinet-side wire 152 may be connected to each other below the hinge plate 331.

For example, the wire hole 242 may be provided on the lower surface of the door 20. The door light 211 may be provided at the lower portion of the door 20. Accordingly, the wire 15 may be connected to the door light 211 through a short path via the wire hole 242 formed in the lower surface of the door 20.

The wire hole 242 may be formed in the cap deco 24. Specifically, the wire hole 242 may be formed in the cap deco 24 at one end of the lower surface adjacent to the guide member 40.

Specifically, the wire hole 242 may be located at a corner formed by the rear end and one side of the left or right sides of the door 20. The wire hole 242 may be positioned on the side of the door 20 that is closer to the hinge 33 among the left and right sides.

The wire hole 242 may be positioned further to the rear than the guide member 40. The wire hole 242 may also be located at a position corresponding to between the left and right ends of the hinge plate 330. In addition, the wire hole 242 may be formed at a position corresponding to between the left and right ends of the guide member 40. Accordingly, a wire guided to the outside of the door 20 through the wire hole 242 may extend toward the cabinet 10 via the hinge 33 along a short path.

Hereinafter, the detailed structure of the guide member 40 and the movement state of the hinge pin 334 during opening and closing of the door 20 will be described in more detail with reference to the drawings.

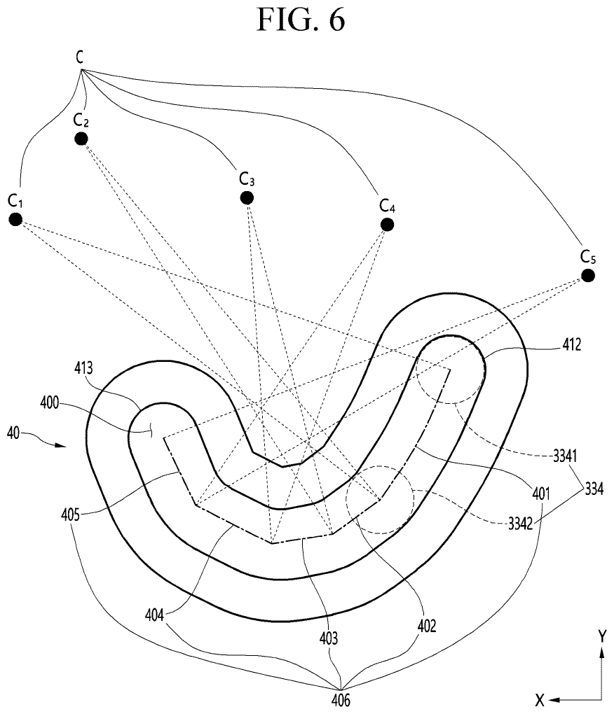

FIG. 6 is a plan view illustrating an arrangement of paths forming guide grooves of the guide member.

As illustrated, a single guide groove 400 formed in the guide member 40 may define a path along which both hinge pins 334 move while inserted. The guide groove 400 may be formed by a plurality of paths 406 extending in different directions and continuously arranged. That is, the hinge pins 334 may sequentially pass through the plurality of paths 406 while moving, and the position of the rotation center C of the door 20 may change so that the door 20 opens and closes. In other words, during the opening and closing process, the door 20 may move while rotating in such a manner that it does not interfere with an adjacent wall, another refrigerator, or other home appliances.

For example, the guide groove 400 may be comprised five paths 406. The paths 406 may extend in different directions, and the five paths 406 may have a structure in which they are continuously connected. The plurality of paths 406 may be formed in various shapes, such as straight shapes, rounded shapes having different curvatures, or arc shapes with different center points, and at least one or more of these shapes may be combined.

The shape of the guide groove 400 determines the movement path of the hinge pins 334, and the position of the moving hinge pins 334 may cause the position of the rotation center C of the door 20 to shift. That is, the rotation center C of the door 20 does not represent a single fixed axis, but rather may be understood as a virtual rotation center that varies according to the paths along which the first hinge pin 3341 and the second hinge pin 3342 move.

For example, the guide groove 400 may be comprised a plurality of paths 406 defined by multiple arcs having different centers. That is, the guide groove 400 may be formed by the first path 401, the second path 402, the third path 403, the fourth path 404, and the fifth path 405 continuously connected together. The centers C of the paths 406 may be located at different positions. In this case, the centers C of the paths 406 may be regarded as virtual centers, which are imaginary points not actually represented on the door 20.

The first path 401 may be formed at one end of the guide groove 400. The first path 401 may be configured such that the hinge pins 334 are positioned therein when the door 20 is in a closed state. That is, the first hinge pin 3341 and the second hinge pin 3342 may be positioned at both ends of the first path 401. The extending direction of the first path 401 may correspond to the arrangement of the first hinge pin 3341 and the second hinge pin 3342. In addition, the length of the first path 401 may correspond to the distance between the centers of the first hinge pin 3341 and the second hinge pin 3342.

Accordingly, the first path 401 may form the path along which the hinge pins 334 move when the door 20 begins to open. In other words, once the hinge pins 334 start to move along the first path 401, the door 20 may be opened.

The first center C1, which is the center of the arc forming the first path 401, may be the point at which a vertical line passing through the contact point between the first hinge pin 3341 and the guide groove 400 intersects with a vertical line passing through the contact point between the second hinge pin 3342 and the guide groove 400.

The first center C1 may be located at a corner region of the front and side surfaces of the door 20 so that the door 20 does not interfere with the wall O when the opening of the door 20 begins. In addition, among the centers C, the first center C1 may be positioned closest to the side of the door 20, that is, at the leftmost (the x-axis direction as shown in FIG. 6) position.

The second path 402 may extend leftward and rearward from the end of the first path 401. The arc length of the second path 402 may be formed shorter than the arc length of the first path 401. The second center C2, which is the center of the arc forming the second path 402, may be located further forward (the y-axis direction as shown in FIG. 6) than the first center C1 and may be positioned farther away from the side of the door 20.

The third path 403 may extend leftward and rearward from the end of the second path 402. The arc length of the third path 403 may be formed shorter than the arc length of the second path 402. The third center C3, which is the center of the arc forming the third path 403, may be located forward (the y-axis direction as shown in FIG. 6) of the first center C1, but farther to the rear than the second center C2. In addition, the third center C3 may be positioned farther away from the side of the door 20 than the second center C2.

The fourth path 404 may extend leftward and forward from the end of the third path 403. The arc length of the fourth path 404 may be formed longer than the arc lengths of the second path 402 and the third path 403, but shorter than the arc length of the first path 401. The fourth center C4, which is the center of the arc forming the fourth path 404, may be located forward (the y-axis direction as shown in FIG. 6) of the first center C1, but farther to the rear than the third center C3. In addition, the fourth center C4 may be positioned farther away from the side of the door 20 than the third center C3.

The fifth path 405 may form the other end of the guide groove 400. The fifth path 405 may be configured such that the hinge pins 334 are positioned therein when the door 20 is in a fully opened state. In this case, the length of the fifth path 405 may be formed shorter than the distance between the centers of the first hinge pin 3341 and the second hinge pin 3342.

The fifth path 405 may extend leftward and forward from the end of the fourth path 404. Both the fifth path 405 and the first path 401 may extend toward the front, and the first path 401 may be formed to extend farther forward than the fifth path 405.

The arc length of the fifth path 405 may be formed longer than the arc lengths of the second path 402 and the third path 403, but shorter than the arc length of the first path 401. The fifth center C5, which is the center of the arc forming the fifth path 405, may be located to the rear of the first center C1 and may be positioned at the rearmost location among the plurality of centers. In addition, the fifth center C5 may be positioned farther away from the side of the door 20 than the fourth center C4. That is, from the first center C1 to the fifth center C5, the centers may be sequentially positioned farther from the side of the door 20. Accordingly, the guide groove 400 may enable smoother movement of the hinge pins 334 and allow smooth opening and closing rotational operations of the door 20.

In another example, a pair of guide grooves may be independently formed in the guide member, and the first hinge pin and the second hinge pin may be inserted into and moved along the respective guide grooves. In yet another example, a plurality of guide members may be provided, and the first hinge pin 3341 and the second hinge pin 3342 may be inserted into the guide grooves formed in the respective guide members.

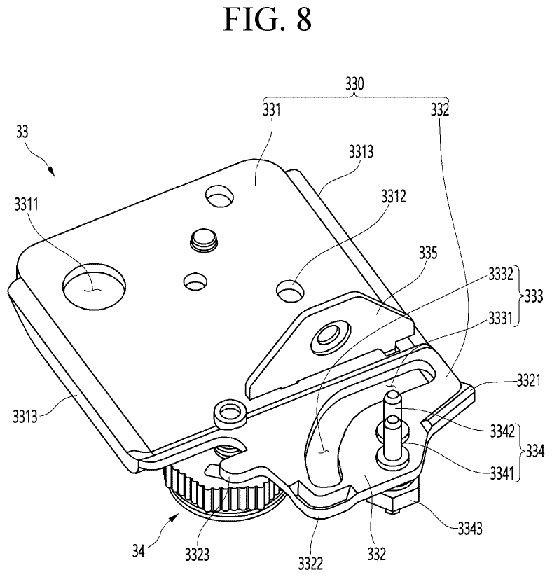

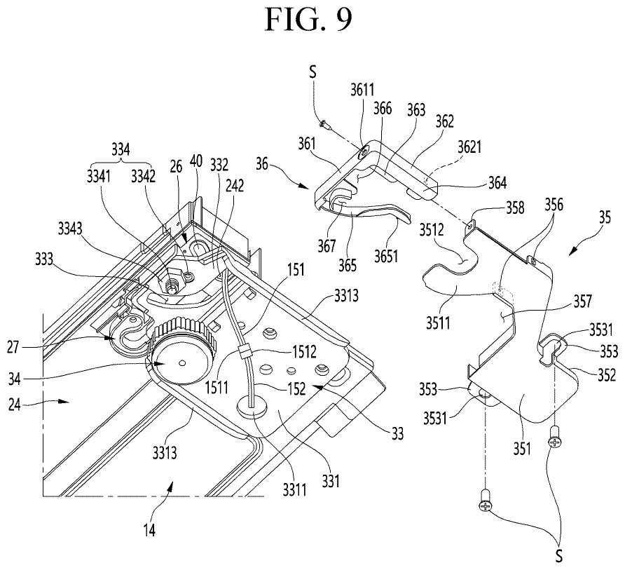

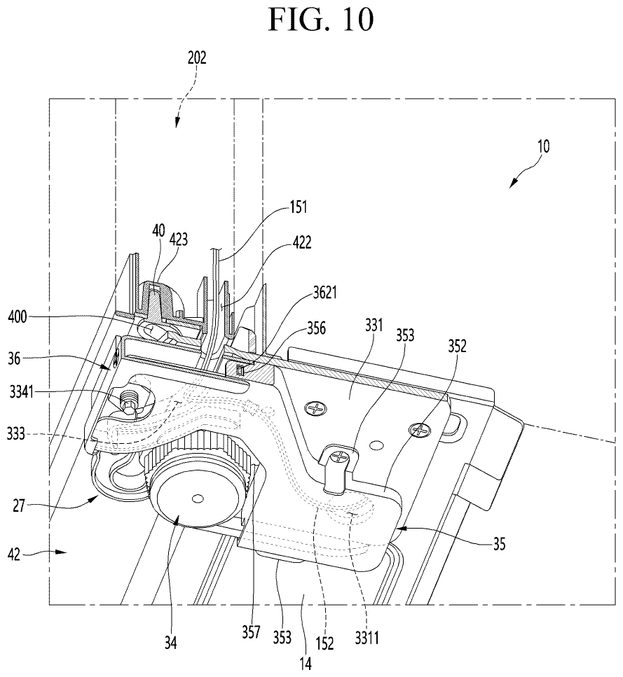

FIG. 7 is an exploded perspective view showing the hinge separated from the main body and the door, FIG. 8 is a perspective view of the hinge, FIG. 9 is an exploded perspective view showing a hinge cover and a hinge cap separated from the hinge, FIG. 10 is a sectional perspective view taken along line 10-10 of FIG. 3.

As illustrated, the hinge plate 330 may include a fixing portion 331 fixed to the bottom surface 14 of the cabinet 10, and a support portion 332 extending from the fixing portion 331 and protruding forward beyond the cabinet 10. The support portion 332 may be a portion protruding forward relative to the cabinet 10.

The fixing portion 331 may be formed as a plate wider than the support portion 332, and may be formed longer than the width of the left and right sides and the length in the front-rear direction of the support portion 332. A screw hole 3312, into which a screw is fastened, may be formed in the fixing portion 331. The screw may pass through the screw hole 3312 and be fastened to the bottom surface 14 of the cabinet 10. Accordingly, the hinge 33 may be firmly coupled to the bottom surface 14 of the cabinet 10.

The fixing portion 331 may be formed with a fixing portion opening 3311 through which the wire 15 is guided into the inside of the cabinet 10. The fixing portion opening 3311 may be formed at the rear portion of the fixing portion 331 and may penetrate the hinge plate 330. The fixing portion opening 3311 may be formed at a position corresponding to the cabinet opening 141 formed in the bottom surface of the cabinet 10. Accordingly, when the hinge 33 is mounted to the cabinet 10, at least a part of the fixing portion opening 3311 and the cabinet opening 141 may overlap each other. Thus, the cabinet-side wire 152 drawn from the inside of the cabinet 10 and the connector 1521 connected to the cabinet-side wire 152 may be arranged to pass through the cabinet opening 141 and the fixing portion opening 3311.

A leg 34 may be formed at the front end of the fixing portion 331. The leg 34 may protrude downward and be supported on the floor. The leg 34 may be screw-coupled to the hinge plate 330, and thus, by rotating the leg 34, the protrusion height of the leg 34 may be adjusted, thereby adjusting the height and inclination of the cabinet 10.

A fixing plate 335 protruding upward may be provided at the front end of the fixing portion 331. The fixing plate 335 may be separately formed and mounted to the front end of the fixing portion 331. The fixing plate 335 may come into close contact with the front surface of the cabinet 10, and a screw may be fastened through the fixing plate 335 to couple the fixing plate 335 to the front surface of the cabinet 10. By fixing the fixing portion 331 and the fixing plate 335 so that they contact the bottom surface 14 and the front surface of the cabinet 10, respectively, the hinge 33 may be maintained in an accurately mounted position.

The support portion 332 may extend forward from the front end of the fixing portion 331. The support portion 332 may extend beneath the door 20 and may be positioned to the rear of the front end of the door 20. The support portion 332 may be stepped or bent at the front end of the fixing portion 331 so that its strength is reinforced. In addition, the support portion 332 may provide a surface on which the hinge pin 334 and the plate opening 333 may be formed.

Meanwhile, on one side of the support portion 332, adjacent to the stopper 27, a restraining protrusion 3323 may be formed. The restraining protrusion 3323 may be engaged and restrained with the elastic portion 272 of the stopper 27.

When the opening and closing of the door 20, the end of the elastic portion 272 may come into contact with the restraining protrusion 3323 and undergo elastic deformation. When the door 20 is closed, the end of the elastic portion 272 may be engaged and restrained by the restraining protrusion 3323, thereby preventing the door 20 from being unintentionally opened.

When the door 20 is rotated in the opening direction, the moment the end of the elastic portion 27 separates from the restraining protrusion 3323, it may be restored after elastic deformation, thereby providing an elastic force in the opening direction of the door 20.

A restricting portion 3321 may be formed on one side of the hinge plate 330 to limit the opening of the door 20. With respect to the hinge pin 334, the restraining protrusion 3323 and the restricting portion 3321 may be arranged on opposite sides. The restricting portion 3321 may come into contact with the restriction protrusion 263 protruding from the lower surface of the door 20 when the door 20 is rotated to its maximum opening angle, thereby preventing the door 20 from being opened further beyond the maximum opening angle.

Meanwhile, the support portion 332 may be provided with the hinge pins 334. The hinge pins 334 may include a first hinge pin 3341 and a second hinge pin 3342. The first hinge pin 3341 and the second hinge pin 3342 may be provided at the front end of the support portion 332 and may be spaced apart from each other in the front-rear direction. In addition, the first hinge pin 3341 and the second hinge pin 3342 may also be spaced apart from each other in the left-right direction.

The first hinge pin 3341 and the second hinge pin 3342 may be fastened to the hinge plate 330. The first hinge pin 3341 and the second hinge pin 3342 may extend vertically upward with respect to the upper surface of the hinge plate 330. Accordingly, the first hinge pin 3341 and the second hinge pin 3342 may be respectively inserted into the guide groove 400 provided on the lower surface of the door 20.

One of the first hinge pin 3341 and the second hinge pin 3342 may form a threaded portion 3344 protruding downward through the hinge plate 330, and a nut 3343 may be fastened to the threaded portion 3344. Accordingly, by rotating the threaded portion 3344 and fastening the nut 3343, the height of the first hinge pin 3341 may be adjusted, thereby adjusting the height of the door 20.

The support portion 332 may be formed with a plate opening 333. The plate opening 333 may guide the wire 15, which is routed from the inside of the door 20 to the outside, to pass through the hinge 33 and extend toward the cabinet 10 side.

To this end, the plate opening 333 may be formed at a position corresponding to the wire hole 242 of the door 20, and may be configured such that the wire passing through the wire hole 242 also passes through the hinge plate 330.

Through the wire hole 242, the door-side wire 151 and a connector 1511 connected to the end of the door-side wire 151 may be drawn out. The door-side wire 151 and the connector 1511 may then pass through the plate opening 333 and be guided to the lower side of the hinge plate 330. For this purpose, the wire hole 242 and the plate opening 333 may be formed in sizes that allow the door-side wire 151 and the connector 1511 to pass through. The connector 1511 of the door-side wire 151 and the connector 1521 of the cabinet-side wire 152 may be coupled and connected to each other below the hinge 33.

The plate opening 333 may be formed in the support portion 332, and the wire hole 242 may be formed at a position facing the plate opening 333. The wire hole 242 may overlap with at least a portion of the plate opening 333 in the vertical direction. Accordingly, the wire 15 inside the door 20 may sequentially pass through the wire hole 242 and the plate opening 333, and then be guided through the hinge 33 toward the cabinet 10.

The plate opening 333 may extend longer than the wire hole 242. The plate opening 333 may also remain in a state of overlapping in the vertical direction with at least a portion of the wire hole 242 even during the opening and closing process of the door 20. That is, the plate opening 333 may be formed to extend along the movement trajectory of the wire hole 242 during the opening and closing of the door 20.

The plate opening 333 may extend from the rear of the hinge pins 334 so as to pass across both the first hinge pin 3341 and the second hinge pin 3342. Specifically, the plate opening 333 may include a first part 3331 extending from one end of the support portion 332 across the pair of hinge pins 334, and a second part 3332 extending in a rounded shape toward the front from the end of the first part 3331.

At this time, the second part 3332 may have a greater curvature than the first part 3331. The first part 3331 may be formed in a straight shape. For example, the first part 3331 may extend from one end of the support portion 332 so as to pass behind the first hinge pin 3341 and the second hinge pin 3342. In this case, the first part 3331 may extend parallel to the front surface of the cabinet 10 or the front surface of the door 20. The second part 3332 may be formed in a rounded shape at the extended end of the first part 3331, and may extend in a rounded manner at the sides of the first hinge pin 3341 and the second hinge pin 3342 to extend toward the front end of the support portion 332.

Meanwhile, since the plate opening 333 is formed to penetrate the hinge plate 330, a structure for reinforcing the strength of the hinge plate 330 may be provided at a position adjacent to the plate opening 333. For example, the hinge plate 330 may be formed with a bending portion 3313. The bending portion 3313 may be bent downward on both sides of the hinge plate 330 to reinforce the strength of the hinge plate 330.

In particular, among the bending portions 3313 on the left and right sides, the bending portion 3313 located closer to the plate opening 333 may extend along the side edges of the fixing portion 331 and the support portion 332. For example, the bending portion 3313 may extend from the rear end of the fixing portion 331, pass along the side of the plate opening 333, and extend to the support portion 332. That is, the bending portion 3313 may be arranged adjacent to one end of the plate opening 333. The end of the bending portion 3313 may extend beyond the plate opening 333 to reach the restricting portion 3321.

In addition, a reinforcing portion 3322 may be further formed to reinforce the strength of the hinge plate 330. The reinforcing portion 3322 may protrude along a part of the perimeter of the support portion 332. The reinforcing portion 3322 may be formed at a position adjacent to one end of the plate opening 333. Specifically, the reinforcing portion 3322 may be formed at a position adjacent to the extended end of the second part 3332 among the ends of the support portion 332. The reinforcing portion 3322 may be formed by shaping the end of the hinge plate 330 to protrude.

Accordingly, the sides of the first part 3331 and the second part 3332 may be reinforced by the bending portion 3313 and the reinforcing portion 3322, and even with the plate opening 333 formed, deformation or damage of the hinge plate 330 due to the load of the door 20 may be prevented.

The hinge plate 330 may be provided with a hinge cover 35 that shields the hinge 33. The hinge cover 35 may shield at least a portion of the hinge plate 330 from below. The hinge cover 35 may be coupled to the hinge plate 330 to provide a space in which the connectors 1511, 1521 of the wire 15 are connected and the wire 15 is arranged. In particular, the hinge cover 35 may be formed in a size and shape capable of shielding both the plate opening 333 and the fixing portion 331. Accordingly, after connecting the connectors 1511, 1521 below the hinge plate 330 and arranging the wire 15, the hinge cover 35 may be coupled to the hinge plate 330 to prevent exposure of the wire 15 and protect it from damage.

The hinge cover 35 may be formed as a plate of metal material and may be bent to form a space in which the wire 15 can be arranged. Specifically, the hinge cover 35 may include a cover body 351 forming the lower surface, and a cover rim 352 extending upward along the perimeter of the cover body 351.

The cover body 351 may extend to shield the plate opening 333 and the fixing portion opening 3311, and may extend along the wiring path of the wire 15. At the front end of the cover body 351, a first recess 3512 may be formed at a position corresponding to the lower end of the first hinge pin 3341 and the adjustment nut 3343, recessed so as not to interfere with the lower end of the first hinge pin 3341 and the adjustment nut 3343. In addition, at the side end of the cover body 351, a second recess 357 may be formed at a position corresponding to the leg 34, recessed so as not to interfere with the leg 34.

Accordingly, in a state where the hinge cover 35 is mounted, the lower end of the first hinge pin 3341 and the adjustment nut 3343 may be positioned in the first recess 3512, and the leg 34 may be positioned in the second recess 357.

At the front end of the cover body 351, a shielding portion 3511 may be formed extending along the extending direction of the plate opening 333. The shielding portion 3511 may shield the plate opening 333 from below. Accordingly, regardless of the position of the wire 15 within the plate opening 333, the wire 15 will not be exposed.

The cover rim 352 may extend so as to come into contact with the lower surface of the hinge plate 330. The cover rim 352 may be formed only in the rear region of the perimeter of the cover body 351, behind the shielding portion 3511.

In addition, the cover rim 352 may be provided with cover coupling portions 353 protruding laterally on both sides. The cover coupling portions 353 may be formed with screw holes 3531 into which screws S are fastened. The screws S may pass through the screw holes 3531 and be fastened to the hinge plate 330, thereby allowing the hinge cover 35 to be securely mounted to the hinge plate 330.

At the front ends of both sides of the cover rim 352, cap coupling grooves 356 may be formed for coupling with a cover cap 36. In addition, at the front end of the cover body 351, a cap coupling portion 358 bent upward may be formed. A screw S may be fastened through the cover cap 36 to the cap coupling portion 358. Accordingly, the cover cap 36 may be coupled to the front portion of the hinge cover 35.

The cover cap 36 is intended to prevent the components between the hinge plate 330 and the door 20 from being exposed to the front and sides, and may be coupled with the hinge cover 35. The cover cap 36 may be formed of a plastic material and, when combined with the hinge cover 35, may shield the front end and side edges of the hinge plate 330. In addition, when mounted, the cover cap 36 may shield the space between the hinge plate 330 and the hinge cover 35 from the front and sides.

Specifically, the cover cap 36 may include a front portion 361 and a side portion 362. The front portion 361 may be positioned in front of the hinge cover 35. A screw hole 3611 for fastening a screw S to couple with the cap coupling portion 358 may be formed in the front portion 361. The front portion 361 may correspond to the length of the front end of the hinge cover 35. The front portion 361 may be formed longer than the left-right length of the plate opening 333. In addition, the front portion 361 may be formed wider than the width of the front end of the support portion 332, thereby shielding the support portion 332 from the front.

The side portion 362 may extend rearward from one end of the support portion 332.

The side portion 362 may extend along the side edge of the support portion 332 and the fixing portion 331. In addition, an extension portion 365 may be formed at the other end of the support portion 332, extending rearward. The extension portion 365 may extend rearward to a position corresponding to the side portion 362. The extension portion 365 may extend along the outer side of the plate opening 333. Accordingly, the extension portion 365 may be formed in a curved shape.

In addition, cap coupling protrusions 3621 and 3651 may be formed on the side portion 362 and the extension portion 365. The cap coupling protrusions 3621, 3651 may be inserted into the cap coupling grooves 356. Accordingly, the cover cap 36 may be coupled to the hinge cover 35. In a state where the cover cap 36 is coupled to the hinge cover 35, the closed space formed by the shielding portion 3511, the front portion 361, the side portion 362, and the extension portion 365 may prevent exposure of the wire 15 passing through the plate opening 333.

Meanwhile, the cover cap 36 may include an upper surface portion 363 formed by bending rearward and sideways from the upper ends of the front portion 361 and the side portion 362. When the cover cap 36 is mounted, the upper surface portion 363 may come into contact with the lower surface of the hinge plate 330.

In addition, a first cover recess 366 and a second cover recess 367 may be formed in the upper surface portion 363. The first cover recess 366 may be recessed at a position corresponding to the lower end of the first hinge pin 3341 and the adjustment nut 3343, thereby preventing interference with the first hinge pin 3341 and the adjustment nut 3343. The second cover recess 367 may be recessed at a position corresponding to one end of the plate opening 333 so that the wire 15 entering or exiting the plate opening 333 is not interfered with.

In addition, the cover cap 36 may include a lower surface portion 364 formed by bending rearward and sideways from the lower ends of the front portion 361 and the side portion 362. When the cover cap 36 is mounted, the lower surface portion 364 may come into contact with the cover body 351.

Hereinafter, the state of the hinge and the hinge-mounting region during opening and closing of the door 20 of the refrigerator 1 having the foregoing structure will be described in detail with reference to the drawings.

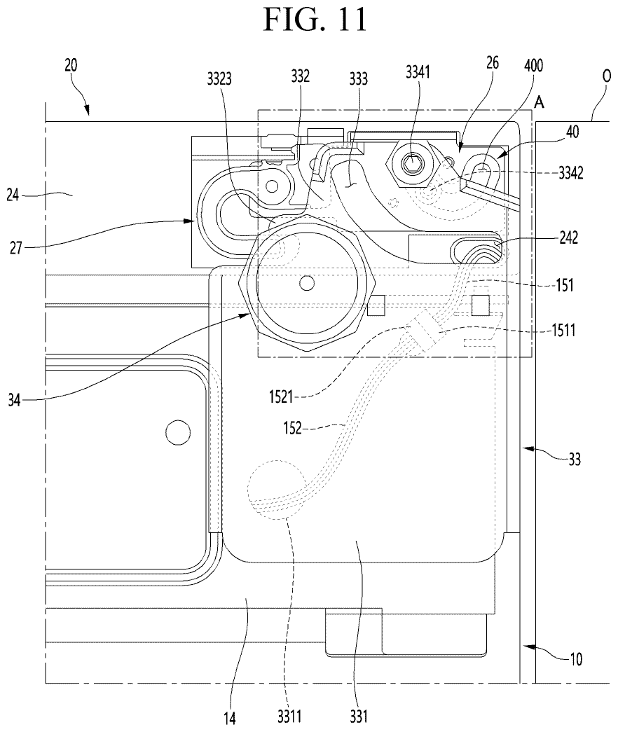

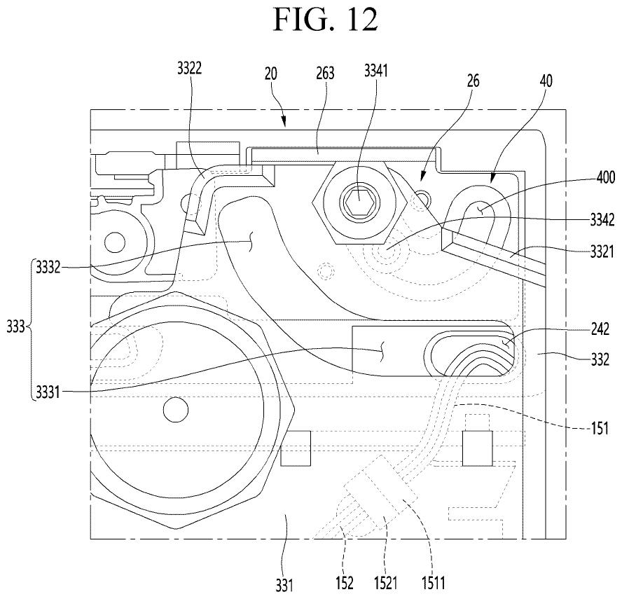

FIG. 11 is a view showing an arrangement state of a wire and hinge pins when the door is in a closed state, and FIG. 12 is an enlarged view of part A of FIG. 11

As illustrated, when the door 20 is in the closed state, the hinge pins 334 may be positioned in the first path 401. That is, the first hinge pin 3341 and the second hinge pin 3342 may be located at both ends of the first path 401. In particular, the second hinge pin 3342 may be positioned at the intersection of the arcs forming the first path 401 and the second path 402. Accordingly, at the moment the opening of the door 20 begins, the second hinge pin 3342 may move into the second path 402.

Meanwhile, the side end of the refrigerator 1 may be positioned adjacent to the wall O with a predetermined gap G1. When the rotational center of the door 20 is located at the edge between the side surface and the front surface of the door 20—where interference with the wall O is expected to occur first at the start of the door opening—interference between the door 20 and the wall surface may be prevented.

Accordingly, in order to guide the rotation of the door 20 at the moment when the opening of the door 20 begins, the first center C1 may be located adjacent to the front and side edge of the door 20. Furthermore, all of the centers C of the plurality of paths 406 constituting the guide groove 400 may be positioned further to the rear than the front surface of the door 20. That is, the centers C of the paths 406 constituting the guide groove 400 may all be located inside the door 20.

In the closed state of the door 20, the elastic portion 272 of the stopper 27 may be engaged and restrained by the restraining protrusion 3323 of the hinge plate 330, thereby preventing the door 20 from being unintentionally opened or remaining partially unclosed.

Meanwhile, when the user performs the opening operation of the door 20, the door 20 may begin to open as it makes an instantaneous movement toward the front and right side along the direction of the first path 401.

At this time, when the door 20 is in the closed state, the wire hole 242 may be positioned at one end of the plate opening 333. Specifically, the wire hole 242 may be located at the end of the first part 3331, in an overlapping state, so that the door-side wire 151 may sequentially pass through the wire hole 242 and the plate opening 333 and be positioned below the hinge plate 330.

In addition, below the hinge plate 330, the cabinet-side wire 152 may be guided into the inside of the cabinet 10 through the fixing portion opening 3311 and the cabinet opening 141. The connector 1511 of the door-side wire 151 and the connector 1521 of the cabinet-side wire 152 may be connected to each other below the hinge plate 330.

Accordingly, the wire 15 may be guided from the inside of the door 20, through the hinge plate 330, and into the inside of the cabinet 10.

At the moment when the opening of the door 20 begins, the first hinge pin 3341 may move along the first path 401, and the second hinge pin 3342 may enter the second path 402. Since the first hinge pin 3341 and the second hinge pin 3342 are positioned in the first path 401 and the second path 402, which extend in different directions, the opening operation of the door 20 can be carried out accurately as the rotational force from the rotation operation is transmitted without twisting or slipping of the door 20.

When the door 20 is further opened, the first hinge pin 3341 may remain positioned in the first path 401, while the second hinge pin 3342 may enter the third path 403. In other words, the second path 402 may be positioned between the first hinge pin 3341 and the second hinge pin 3342.

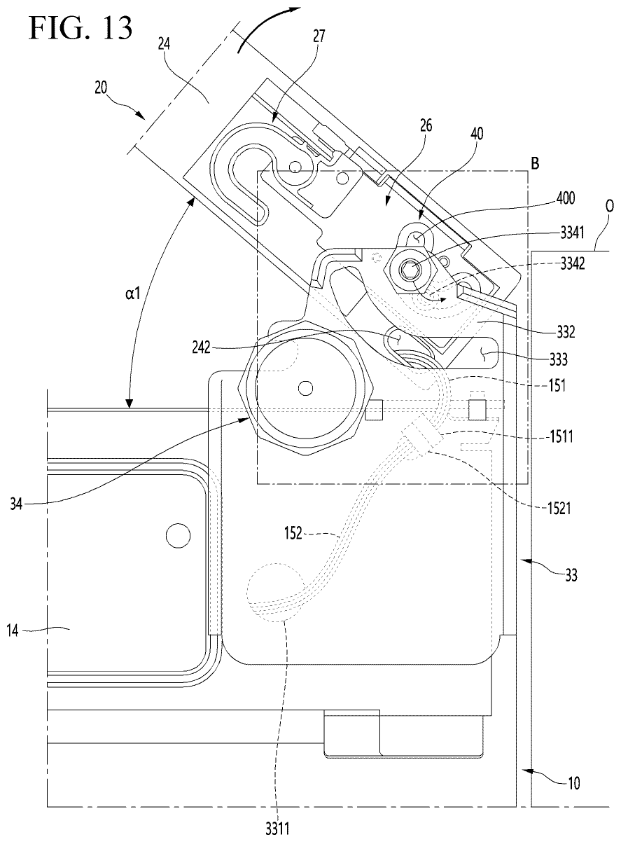

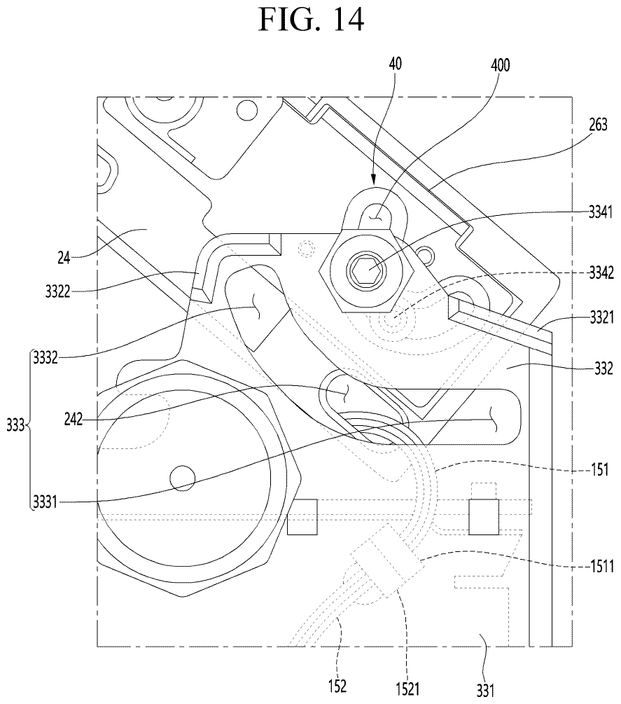

FIG. 13 is a view showing an arrangement state of a wire and hinge pins when the door is opened at a predetermined angle, FIG. 14 is an enlarged view of part B of FIG. 13.

When the door 20 is further opened by a set angle α1 (for example, 45°), the first hinge pin 3341 may move into the third path 403, and the second hinge pin 3342 may move along the fourth path 404. In other words, the third path 403 may be positioned between the first hinge pin 3341 and the second hinge pin 3342.

In this state, the edge of the door 20 may be closest to the wall O by a predetermined gap G2, and the door 20 may rotate without striking the wall O. Furthermore, the hinge pins 334 may move smoothly along the guide groove 400, and the first hinge pin 3341 and the second hinge pin 3342 may move respectively along the different second path 402 and fourth path 404, thereby allowing the door 20 to rotate without twisting or slipping.

As the door 20 moves to open, the wire hole 242 also moves. Since the shape of the plate opening 333 corresponds to the movement trajectory of the door 20, the wire hole 242 may be able to move along the plate opening 333.

That is, the wire hole 242 may be positioned at a location overlapping with the plate opening 333, specifically at the point where the first part 3331 and the second part 3332 are connected. Even in this state, the wire hole 242 and the plate opening 333 remain overlapped, allowing the door-side wire 151 to sequentially pass through the wire hole 242 and the plate opening 333, while the cabinet-side wire 152 passes through the fixing portion opening 3311 and the cabinet opening 141 to be guided into the cabinet 10. In addition, the connector 1511 of the door-side wire 151 and the connector 1521 of the cabinet-side wire 152 may remain connected below the hinge plate 330.

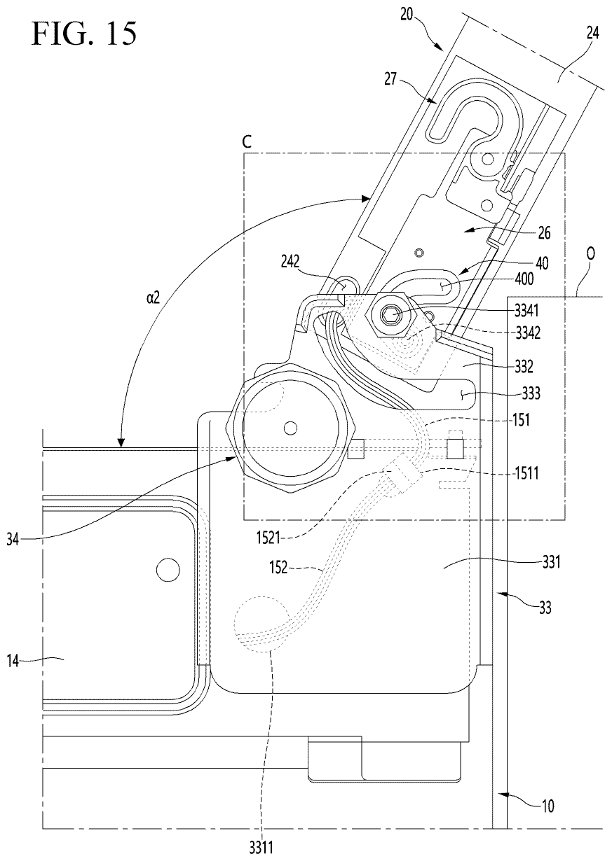

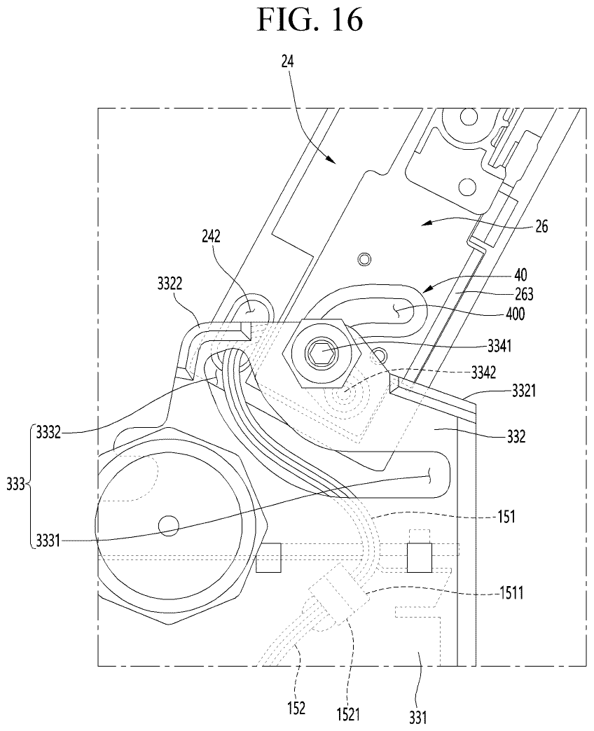

FIG. 15 is a view showing an arrangement state of a wire and hinge pins when the door is in a fully open state, FIG. 16 is an enlarged view of part C of FIG. 15.

As illustrated, when the door 20 is opened to a maximum angle α2 (for example, 120°), the first hinge pin 3341 may move into the fourth path 404, and the second hinge pin 3342 may move to the end of the fifth path 405.

In this state, the front surface of the door 20 may be separated from the wall O by a predetermined gap G3, ensuring that the door 20 does not collide with the wall O. The hinge pins 334 may remain stationary inside the guide groove 400, with the second hinge pin 3342 abutting the end of the fifth path 405, thereby preventing the door 20 from opening further and maintaining it in a stopped state.

As such, during the opening and closing process of the door 20, the hinge pins 334 move along the paths of the guide groove 400, and the door 20 moves while its rotational center C changes, thereby allowing it to open without colliding with the wall O.

Furthermore, even when the door 20 is fully opened, the wire hole 242 may be positioned so as to overlap with the plate opening 333. Specifically, the wire hole 242 may be located at the end of the second part 3332. In this state, the wire hole 242 and the plate opening 333 remain overlapped, allowing the door-side wire 151 to sequentially pass through the wire hole 242 and the plate opening 333, while the cabinet-side wire 152 passes through the fixing portion opening 3311 and the cabinet opening 141 to be guided into the interior of the cabinet 10. In addition, the connector 1511 of the door-side wire 151 and the connector 1521 of the cabinet-side wire 152 may remain connected to each other below the hinge plate 330.

Accordingly, from the closed state of the door 20 to its fully opened state, the wire hole 242 moves along the plate opening 333 while maintaining an overlapping state with the plate opening 333. Thus, the wire 15 inside the door 20 may pass through the hinge 33 and be guided toward the cabinet 10.

The process of closing the door 20 may be carried out in the reverse order of the aforementioned embodiment.

Meanwhile, in addition to the foregoing embodiment, various other embodiments of the present invention are also possible. Hereinafter, another embodiment of the present invention will be described with reference to the drawings. Among the components of the other embodiment of the present invention, components identical to those of the foregoing embodiment may have their detailed description and illustration omitted, and the same reference numerals may be used to describe them. That is, only the structures differing from the foregoing embodiment will be described below, while other components not described may be the same as those of the foregoing embodiment.

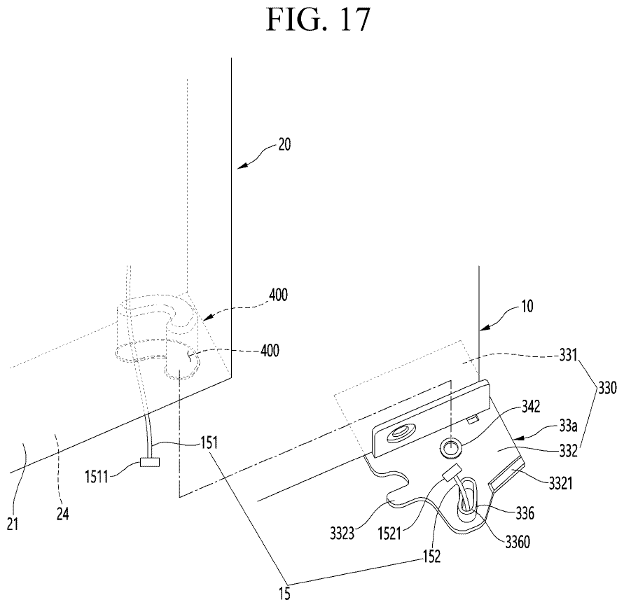

FIG. 17 is an exploded perspective view of a door according to a second embodiment of the present invention.

As illustrated, the refrigerator 1 according to the second embodiment of the present invention may include a cabinet and a door 20. The door 20 may be rotatably connected to the cabinet 10 by means of a hinge 33a.

The hinge 33a may include a hinge plate 330 mounted to the cabinet 10 and a hinge portion 336 protruding from the hinge plate 330 toward the door 20. The hinge plate 330 may be formed in the same manner as in the foregoing embodiment.

The hinge plate 330 may include a fixing portion 331 coupled to the cabinet 10 and a support portion 332 extending forward from the front end of the fixing portion 331. A leg may be mounted on the support portion 332. In addition, the support portion 332 may be provided with a restriction protrusion 3323 and a limiting portion 3321.

In addition, a hinge portion 336 may be formed on the upper surface of the support portion 332 so as to protrude upward. The hinge portion 336 may be formed in a shape corresponding to a part of the guide groove 400 described below. Specifically, the hinge portion 336 may be formed to correspond to the shape of the first path 401 formed in the guide groove 400 of the foregoing embodiment.

The perimeter of the hinge portion 336 may extend to a height insertable into the interior of the guide groove 400, and the upper surface of the hinge portion 336 may be open to include a through-hole 336 that penetrates the hinge plate 330. Through the through-hole 336, the cabinet-side wire 152 extending from the cabinet 10 and the connector 1521 may be drawn in and out. The through-hole 336 may be formed in an elongated shape and may correspond in shape to the first path 401.

An electric component, such as the door light 211 of the first embodiment described above, may be provided inside the door 20. The door-side wire 151 connected to the electric component may be guided to the outside of the door 20.

A cap deco 24 may be provided on the lower surface of the door 20, and the guide member 40 may be mounted on the cap deco 24. Inside the guide member 40, a guide groove 400 may be formed to define a path into which the hinge portion 336 is inserted and moved. The guide groove 400 may be formed to have a plurality of continuous paths, as in the foregoing embodiment.

The hinge portion 336 may be inserted into the interior of the guide groove 400, and during the opening and closing operation of the door 20, the hinge portion 336 may move along the guide groove 400 while being in contact with the inner surface of the guide groove 400. Among the plurality of paths formed in the guide groove 400, the first path 401 may be formed at the position where the hinge portion 336 is located when the door 20 is in the closed state.

In addition, a guide hole 414 may be formed on the upper surface of the guide member 40 to communicate with the interior of the door 20. The guide hole 414 may be formed along the guide groove 400 and may be opened so that the wire 15 connected to the electric component inside the door 20 can pass through.

The connector 1511 of the door-side wire 151, which is guided downward of the hinge plate 330 through the through-hole 336 and the guide groove 400, may be connected to the connector 1521 of the cabinet-side wire 152. Accordingly, the wire 15 inside the door 20 may pass through the hinge plate 330 and be guided toward the cabinet 10.

Furthermore, even with the wire 15 arranged, the door 20 may still be opened and closed. As the door 20 is operated, the hinge portion 336 may move along the guide groove 400, while the wire 15 may remain in a state of passing through the hinge portion 336 and the guide groove 400.

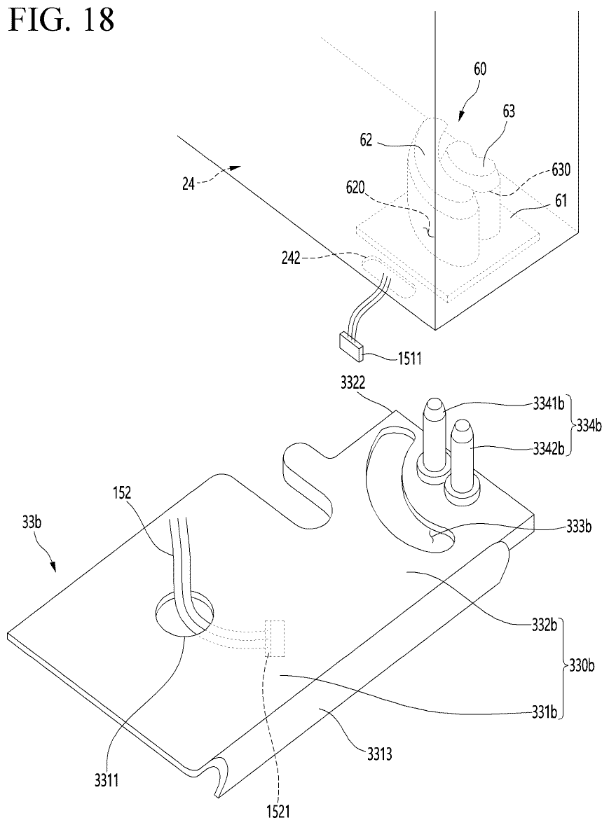

FIG. 18 is an exploded perspective view of a door according to a third embodiment of the present invention.

As illustrated, a refrigerator 1 according to a third embodiment of the present invention includes a hinge 33b that connects the cabinet 10 and the door 20. In this case, the hinge 33b may support the door 20 from below.

The hinge 32 may include a hinge plate 330b and a hinge pin 334b. The hinge plate 330b may include a fixing part 331b fixed to the cabinet 10, and a support part 332b extending from the fixing part 331b and extending to the lower surface of the door 20.

The hinge pin 334b may be mounted on the support part 332b and may extend upward from the upper surface of the hinge plate 330b. The hinge pin 334b may include a first hinge pin 3341b and a second hinge pin 3342b, which are spaced apart from each other.

The first hinge pin 3341b and the second hinge pin 3342b may be arranged side by side while being spaced apart from each other in the left-right direction. Of course, the first hinge pin 3341b and the second hinge pin 3342b may also be spaced apart in the front-rear direction. The first hinge pin 3341b may be positioned farther from the side edge of the door.

A plate opening 333b may be formed in the support part 332b. The plate opening 333b may allow a wire 15 extending from the door 20 to pass through and be guided toward the cabinet 10. Specifically, the plate opening 333b may allow the cabinet-side wire 152 extending from the cabinet 10 and the connector 1521 at the end of the cabinet-side wire 152 to pass through.

The plate opening 333b may be formed between the hinge pin 334b and the front surface of the cabinet 10. At least a portion of the plate opening 333b may be formed in a rounded shape. For example, the plate opening 333b may be formed to correspond to the movement trajectory of the wire hole 242 when the door 20 is opened and closed. In addition, the hinge plate 330b may further include a bending portion 3313 and a reinforcing portion 3322.

The lower surface of the door 20 may be provided with a guide member 60 that guides the movement of the hinge pin 334b. The guide member 60 may be separately molded and mounted on the cap deco 24 forming the lower surface of the door 20. The guide member 60 may be formed with guide grooves 620, 630 that define paths into which the hinge pin 334b is inserted and moved. The guide member 60 may include a base 61 mounted to the cap deco 24, and the guide grooves 620, 630 may be respectively opened in the base 61.

The guide member 60 may include a first guide portion 62 into which the first hinge pin 3341b is inserted, and a second guide portion 63 into which the second hinge pin 3342b is inserted. That is, the guide member 60 may have independent paths respectively guiding the first hinge pin 3341b and the second hinge pin 3342b.

The first guide portion 62 may be provided with a first guide groove 620 at a position corresponding to the first hinge pin 3341b. The first guide groove 620 may be opened downward so that the first hinge pin 3341b can be inserted therein. The first guide groove 620 may form a path along which the first hinge pin 3341b moves during opening and closing of the door 20, and the circumference of the first hinge pin 3341b may move while being in contact with the inner surface of the first guide groove 620. For example, the first guide groove 620 may be formed in an arc shape having a predetermined curvature. Of course, if necessary, the first guide groove 620 may have a shape in which a plurality of arcs with different curvatures are connected. In addition, the first guide groove 620 may be configured as a combination of inclined and rounded shapes.

The second guide portion 63 may be provided with a second guide groove 630 at a position corresponding to the second hinge pin 3342b. The second guide groove 630 may be opened downward so that the second hinge pin 3342b can be inserted therein. The second guide groove 630 may form a path along which the second hinge pin 3342b moves during opening and closing of the door 20, and the circumference of the second hinge pin 3342b may move while being in contact with the inner surface of the second guide groove 630. For example, the second guide groove 630 may be formed in an arc shape having a predetermined curvature. Of course, if necessary, the second guide groove 630 may have a shape in which a plurality of arcs with different curvatures are connected. In addition, the second guide groove 630 may be configured as a combination of inclined and rounded shapes.

Meanwhile, the first guide groove 620 may be formed longer than the second guide groove 630 and may be disposed closer to the cabinet 10. That is, during opening and closing of the door 20, the movement trajectory of the first hinge pin 3341b may be formed larger than the movement trajectory of the second hinge pin 3342b.

Accordingly, during the opening and closing operation of the door 20, the first hinge pin 3341b and the second hinge pin 3342b may move along the first guide groove 620 and the second guide groove 630, respectively. In the same manner as the door 20 of the first embodiment described above, the rotational center of the door 20 continuously changes as the first hinge pin 3341b and the second hinge pin 3342b come into contact with the first guide groove 620 and the second guide groove 630 during the opening and closing movement. As a result, the door 20 can be opened and closed smoothly without colliding with an adjacent wall surface.

Meanwhile, a wire hole 242 may be formed on the lower surface of the door 20. The wire hole 242 may be configured to allow the door-side wire 151, which extends from the inside of the door 20, and the connector 1511 at the end of the door-side wire 151, to pass through. For example, the door-side wire 151 may be connected to the door light 211.

The wire hole 242 may be positioned vertically above the plate opening 333b.

Accordingly, at least a portion of the wire hole 242 may overlap with the plate opening 333b. Furthermore, even while the door 20 is being opened or closed, the wire hole 242 may move along the plate opening 333b while maintaining an overlapping state with the plate opening 333b.

Accordingly, the door-side wire 151 may be guided downward through the wire hole 242 and the plate opening 333b to the underside of the hinge plate 330b. Beneath the hinge plate 330b the connector 1511 of the door-side wire 151 and the connector 1521 of the cabinet-side wire 152 may be connected to each other. The cabinet-side wire 152, as in the previously described embodiment, may pass through the fixing portion opening 3311 and the cabinet opening 141 to be guided into the cabinet 10. In addition, the hinge plate 330b may be further provided with the hinge cover 35 and the hinge cap 36, as in the previously described embodiment.

What is claimed is:

1. A refrigerator comprising:
a cabinet having a storage space with an open front;
a door configured to open and close the storage space;
a hinge including a hinge plate mounted on the cabinet and a pair of hinge pins protruding from the hinge plate; and
a guide member provided on the door to allow the pair of hinge pins to be inserted and forming a path along which the hinge pins move when the door is opened and closed; and
wherein a plate opening is formed in the hinge plate through which a wire extending from an interior of the door passes and is guided toward the cabinet.

2. The refrigerator according to claim 1, wherein a wire hole formed independently of the guide member is formed on one surface of the door provided with the guide member, and
wherein the wire passes through the wire hole and is guided to an outside of the door.

3. The refrigerator according to claim 2, wherein the wire hole is formed at a position facing the plate opening.

4. The refrigerator according to claim 2, wherein the wire hole overlaps at least a portion of the plate opening in a vertical direction.

5. The refrigerator according to claim 2, wherein the plate opening is formed along a moving trajectory of the wire hole when the door is opened or closed.

6. The refrigerator according to claim 2, wherein the plate opening extends longer than the wire hole, and
wherein the plate opening maintains a vertical overlap with a portion of the wire hole even during the opening or closing of the door.

7. The refrigerator according to claim 2, wherein the wire hole is located in a region between both ends of the guide member and is disposed further rearward than the guide member.

8. The refrigerator according to claim 1, wherein the hinge plate includes:
a fixing portion fixed to a lower surface of the cabinet; and
a support portion extending from the fixing portion and protruding further forward than the cabinet, and to which the pair of hinge pins are mounted, and
wherein the plate opening is formed at the support portion.

9. The refrigerator according to claim 8, wherein the plate opening is formed in the support portion and extends from a rear of the pair of hinge pins to pass through both of the pair of hinge pins.

10. The refrigerator according to claim 9, wherein the plate opening comprises:
a first part extending from an end of the support portion to pass the pair of hinge pins; and
a second part extending forward in a rounded manner from an end of the first part, and
wherein the second part has a greater curvature than the first part.

11. The refrigerator according to claim 10, wherein the first part is formed in a linear shape.

12. The refrigerator according to claim 8, wherein the hinge plate further includes a bending portion formed by bending along side edges of the support portion and the fixing portion, and
wherein the bending portion is adjacent to an end of both ends of the plate opening.

13. The refrigerator according to claim 8, wherein the hinge plate further includes a reinforcing portion protruding along a portion of a periphery of the support portion, and
wherein the reinforcing portion is adjacent to another end of both ends of the plate opening.

14. The refrigerator according to claim 8, wherein a fixing portion opening is formed in the fixing portion, the fixing portion opening being configured to guide the wire, which has passed through the plate opening, toward the cabinet.

15. The refrigerator according to claim 14, wherein a hinge cover that shields the hinge is coupled to the hinge plate, and
wherein the hinge cover covers both the plate opening and the fixing portion opening.

16. The refrigerator according to claim 1, wherein the hinge connects a lower surface of the cabinet and a lower surface of the door.

17. The refrigerator according to claim 1, wherein the pair of hinge pins extend in parallel at spaced-apart positions so as to contact an inner surface of the guide member, and
wherein a point of contact between the hinge pins and the inner surface of the guide member is continuously changed during opening and closing of the door.

18. The refrigerator according to claim 1, wherein the door comprises:
a front panel defining a front surface of the door and being light-transmissive;
a lighting device provided in the door, the lighting device being configured to irradiate light toward the front panel to adjust a color of the front surface of the door; and
a cap deco defining an upper surface or a lower surface of the door, and
wherein the wire extends from the lighting device and is guided into the cabinet through a wire hole formed in the cap deco and the plate opening.

19. The refrigerator according to claim 1, wherein the guide member comprises a pair of guide grooves formed independently of each other, and
wherein the pair of hinge pins are respectively inserted into the pair of guide grooves.

20. A refrigerator comprising:
a cabinet having a storage space;
a door configured to open and close the storage space;
a hinge including a hinge plate mounted to the cabinet and a hinge portion protruding from the hinge plate toward the door;
a guide member provided in the door such that the hinge portion is inserted therein, the guide member forming a path along which the hinge portion moves during opening and closing of the door; and
a wire disposed inside the door and extending through the hinge to be guided into the cabinet,
wherein the hinge portion is formed with a through-hole penetrating the hinge portion,
wherein the guide member is formed with a guide hole opened at a position facing the through-hole and opened along the path, and
wherein the wire passes through the guide hole and the through-hole to be guided from inside the door to the cabinet.
